(19) United States
(12) Patent Application Publication
(10) Pub. No.: US 2026/0097976 A1
(43) Pub. Date: Apr. 9, 2026

(54) APPARATUSES AND METHODS FOR CLARIFYING LIQUIDS

(71) Applicant: CLEARFLOW GROUP INC., Sherwood Park (CA)

(72) Inventor: Gerald HANNA, Sherwood Park (CA)

(73) Assignee: CLEARFLOW GROUP INC., Sherwood Park (CA)

(21) Appl. No.: 19/348,307

(22) Filed: Oct. 2, 2025

Related U.S. Application Data
(60) Provisional application No. 63/702,651, filed on Oct. 3, 2024.

(51) Int. Cl. C02F 1/56; C02F 1/52; C02F 101/10; C02F 103/42

(52) U.S. Cl. CPC C02F 1/56; C02F 1/5236; C02F 2101/105; C02F 2103/42; C02F 2201/002

(57) ABSTRACT

An apparatus and method are provided for clarifying liquids such as water in swimming pools, hot tubs, spas, and the like by removing phosphorus, particles, and suspended solids including, but not limited to, fines and ultra-fines from the water. The apparatus includes a perforated enclosure for holding one or more types of gel flocculant, wherein the apparatus is placed in a skimmer unit of the pool, hot tub, spa, and the like whereby water drawn into the skimmer contacts and absorbs the gel flocculant through the perforations of the enclosure. The absorbed flocculant acts to bind together the phosphorus, particles, and suspended solids in the water, as the water circulates through a water treatment system, into clumps that either precipitate out of the water or are filtered out by a filter in the water treatment system.

### CROSS-REFERENCE TO RELATED APPLICATIONS

This application claims priority of United States Provisional Patent Application Ser. No. 63/702,651 filed Oct. 3, 2024, which is incorporated by reference into this application in its entirety.

### TECHNICAL FIELD

The present disclosure is related to the field of apparatuses and methods for clarifying liquids, in particular, clarifying water used in swimming pools, hot tubs, spas, and the like.

### BACKGROUND

Swimming pools, hot tubs, spas, and the like can take on a swampy, green appearance if they are neglected due to the buildup of algae. Algae are microscopic creatures that thrive in the right conditions, typically bright light and hot weather. High sunlight, muggy temperatures, low levels of chlorine, or the buildup of phosphates, carbon dioxide, or nitrates can result in a green pool.

Fixing a “green pool” means fixing the water's chemical imbalance. Professional pool cleaning services can do this. However, regular pool maintenance and cleaning is required to prevent this issue from happening again. The water filter should always be in working order to prevent a stagnant pool, which creates the optimal conditions for algae and organisms to grow. If a green pool is a persistent problem, the chemicals used and sanitation system might be responsible. While ozone sanitation may cut chlorine use by as much as 90%, these systems still use chlorine and may take days or weeks to be effective. If these systems continually fail you, it might be time to get an upgrade or invest in pool cleaning services more often.

Irregular maintenance may result in a thick, oily film on pool walls and surfaces. Even the most experienced swimmers might slip and fall on a slick ladder or slippery steps. It's important to keep chemicals balanced and films and residue at bay to ensure your pool and its occupants safe.

Without proper maintenance and care, a dirty pool can cause recreational water illnesses (“RWIs”). These illnesses include diarrhea, ear infections, respiratory infections, rashes, and/or inflamed eyes and lungs. That may sound alarming, but a well-maintained pool leaves nothing to fear. According to the Mayo Clinic's infectious disease consultant Dan DeSimone, “As long as the pH and chlorine levels in the pool are being maintained, the disinfectants will kill off most germs that could make you ill.” Nearly all germs are eradicated in an hour or less with the right amount of chlorine in the pool.

RWIs can happen when an unclean pool harbors excess bacteria. When you dive underwater, that bacteria may build up in your ear, causing an ear infection, otherwise known as swimmer's ear. You also have a chance of catching the bacterial strain Pseudomonas aeruginosa. This bacterium is well-known for occurring in unclean hot tubs, but it is possible to see these bacteria in your pool. This particular bacterium buildup leads to itchy red bumps, informally known as hot tub rash. If you notice signs of these infections, visit your doctor and swim only after your pool has been treated.

Without proper maintenance, swimming pool water can become a breeding ground for harmful bacteria, algae, and other contaminants. Swimmers may be at risk of skin infections, respiratory issues, and other health problems if the water is not adequately sanitized and balanced.

Prior art methods for maintaining and cleaning pools can include the use of toxic chemicals such as copper (II) sulphate (CuSO₄), sodium hypochlorite (NaOCl), malachite green, and high-dose chlorines (shock) to act as anti-bacterials and or anti-fungals or various forms of algaecide. Each of these are harmful to humans, mammals and aquatic organisms. Other than extremely costly ultraviolet (“UV”) systems there are no products on the market that are an all in one solution to algae and total suspended solids (“TSS”) reduction for pools or ponds that are safe for the environment animals and aquatic organisms. Prior art pool treatment methods require a myriad of liquid and/or granular chemicals to maintain water balance. Due to toxicity levels and potential for human harm, there is a minimum of 2 hours required prior to use of a pool once these chemicals have been put in.
1—Water clarifier
2—Algaecide
3—pH stabilizer
4—Shock (high dose chlorine)
5—Chlorine maintenance

It is, therefore, desirable to provide apparatuses and methods for clarifying liquids, such as water used in swimming pools, hot tubs, spas, and the like, that are simpler, safer, easier to use, take less time to implement, and less expensive than traditional, prior art apparatuses and methods that are currently used.

### SUMMARY

Apparatuses and methods for clarifying liquids, such as water used in swimming pools, hot tubs, spas, and the like is provided.

In some embodiments, the apparatus can comprise a perforated enclosure that can hold one or more amounts of a flocculant composition, wherein the apparatus can be placed within a skimmer unit of a swimming pool, hot tub, spa or the like such that water drawn into the skimmer unit can contact the flocculant composition(s) through the perforations of the enclosure. In so doing, the flocculant can be absorbed by the water flowing into the skimmer unit and throughout the pool water treatment system to clarify the water, meaning, to absorb and to remove therefrom phosphorus, particles, and suspended solids including, but not limited to, fines and ultra-fines. Fine particles are generally considered to be 100-2500 nm in diameter¹, whereas ultra-fine particles are generally considered to be 100 nm or less in diameter². ¹ https://www.sciencedirect.com/topics/materials-science/fine-particle² Ibid.; and https://en.wikipedia.org/wiki/Ultrafine_particle

In some embodiments, a first gel flocculant can be placed in the perforated enclosure that can be specifically designed to remove total suspended solids (“TSS”), which can include metals, clays, and phosphorus. A second gel flocculant can be placed in the perforated enclosure that be specifically designed to enhance binding of the TSS as well as the metals, clays, and phosphorus by amplifying the charge capacity of the first gel flocculant. In some embodiments, this gel flocculant combination can create tightly bound flocculated material that can have a sheer capacity that will not break down when pumped or piped through the pool water treatment system with high turbulence.

Although not an algaecide, the gel flocculant can remove phosphorus in total and dissolved format from the water. Phosphorus provides nourishment for algae. Once the phosphorus is removed from the water, the algae will have no nutrient supply and will die off. Secondarily, the organic material of the algae has an ionic charge and when the gel flocculant is released into the water, the ionic charges can create a binding mechanism with the gel flocculant, and the ionic charge in the organic material can thus cause binding of the algae material. Once bound together, the agglomerated material can increase in mass and size and then fall out of the water column. In some cases, if the specific gravity of the amassed algae is not enough to fall out, then the clumped algae may float on the surface of the water thus allowing for easy capture via filtration. The algae that precipitates to the bottom of the pool can be easily captured via vacuum or filtration once drawn from the pool, hot tub, or spa. The continual cycle of the water through the pool water treatment system in combination with the two types of gel flocculants through the circulatory pumps can inhibit future growth of algae due to the removal of phosphorus from the water.

In some embodiments, the flocculant compositions used in the apparatus can comprise a polymer, a soluble salt of a group IA metal or of a group IIA metal of the periodic table, and water. In other embodiments, the soluble salt of a group IA metal or the soluble salt of a group IIA metal can be formed by combining a salt of a group IA metal or a salt of a group IIA metal with a mineral acid or an organic acid.

In some embodiments, the flocculant compositions can be manufactured by first combining the polymer and the alkaline earth metal soluble salt, and then adding the water.

Broadly stated, in some embodiments, an apparatus for clarifying a liquid, the apparatus comprising: a perforated enclosure; and at least one first flocculant composition disposed in the perforated enclosure.

Broadly stated, in some embodiments, the at least one first flocculant composition can comprise: a polymer flocculant comprising a high molecular weight, in a proportion of approximately 10% to 70% by weight; a soluble salt of a group IA metal or a soluble salt of a group IIA metal, in a proportion of approximately 0.5% to 35% by weight; and water, in a proportion to make up a balance of 100% weight.

Broadly stated, in some embodiments, the apparatus can further comprise at least one second flocculant composition disposed in the perforated enclosure.

Broadly stated, in some embodiments, the at least one second flocculant composition can comprise: a polymer flocculant comprising a high molecular weight, in a proportion of approximately 10% to 70% by weight; a soluble salt of a group IA metal or a soluble salt of a group IIA metal, in a proportion of approximately 0.5% to 35% by weight; and water, in a proportion to make up a balance of 100% weight.

Broadly stated, in some embodiments, the textile material can comprise a Leno weave.

Broadly stated, in some embodiments, the at least one second flocculant composition can comprise a different composition than that of the at least one first flocculant composition.

Broadly stated, in some embodiments, the enclosure comprises an open-top body and a lid configured to releasably attach to the open-top body.

Broadly stated, in some embodiments, the apparatus can further comprise a catch mechanism for releasably attaching the lid to the open-top body.

Broadly stated, in some embodiments, the at least one first flocculant composition can comprise a gel flocculant.

Broadly stated, in some embodiments, the at least one second flocculant composition comprises a gel flocculant.

Broadly stated, in some embodiments, the liquid can comprise of water from one or more of a swimming pool, a hot tub, and a spa.

Broadly stated, in some embodiments, a method can be provided for clarifying liquids, the method comprising placing an apparatus into a liquid treatment system, the apparatus comprising: a perforated enclosure; and at least one first flocculant composition disposed in the perforated enclosure.

Broadly stated, in some embodiments, the method can further comprise placing the apparatus into a skimmer unit of a water treatment system for one or more of a swimming pool, a hot tub, and a spa.

### BRIEF DESCRIPTION OF THE DRAWINGS

FIG. 1 is a top plan view depicting one embodiment of an apparatus for clarifying liquids.

FIG. 2 is a side perspective view depicting the apparatus of FIG. 1.

FIG. 3 is a rotated side elevation view depicting the apparatus of FIG. 1.

FIG. 4 is a close-up, side perspective view depicting the apparatus of FIG. 1.

FIG. 5 is a perspective view depicting the apparatus of FIG. 1 having a first flocculating composition disposed in a first basket of the apparatus, and a second flocculating composition disposed in a second basket of the apparatus.

FIG. 6 is a side perspective view depicting the apparatus of FIG. 5.

FIG. 7 is a perspective view depicting the apparatus of FIG. 5 attached to a swimming pool skimmer lid with a line.

FIG. 8 is a perspective view depicting the apparatus of FIG. 7 being lowered into a swimming pool skimmer.

FIG. 9 is a perspective view depicting the skimmer lid of FIG. 7 being closed upon the skimmer of FIG. 8.

FIG. 10 is a top perspective view depicting one embodiment of a lid for use with the apparatus of FIG. 1.

FIG. 11 is a bottom perspective view depicting the lid of FIG. 10.

FIG. 12 is a top perspective view depicting a bottom for use with the apparatus of FIG. 1.

FIG. 13 is a bottom perspective view depicting the bottom of FIG. 12.

FIG. 14 is a top plan view depicting one embodiment of the apparatus of FIG. 1 placed in a pool skimmer.

FIG. 15 is a top plan view depicting the apparatus of FIG. 14 where water in the pool skimmer is reacting with gel flocculant disposed in the apparatus.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more”when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

In some embodiments, an apparatus for clarifying liquids is provided. In some embodiments, the liquids can comprise of water used in swimming pools, hot tubs, spas, and the like.

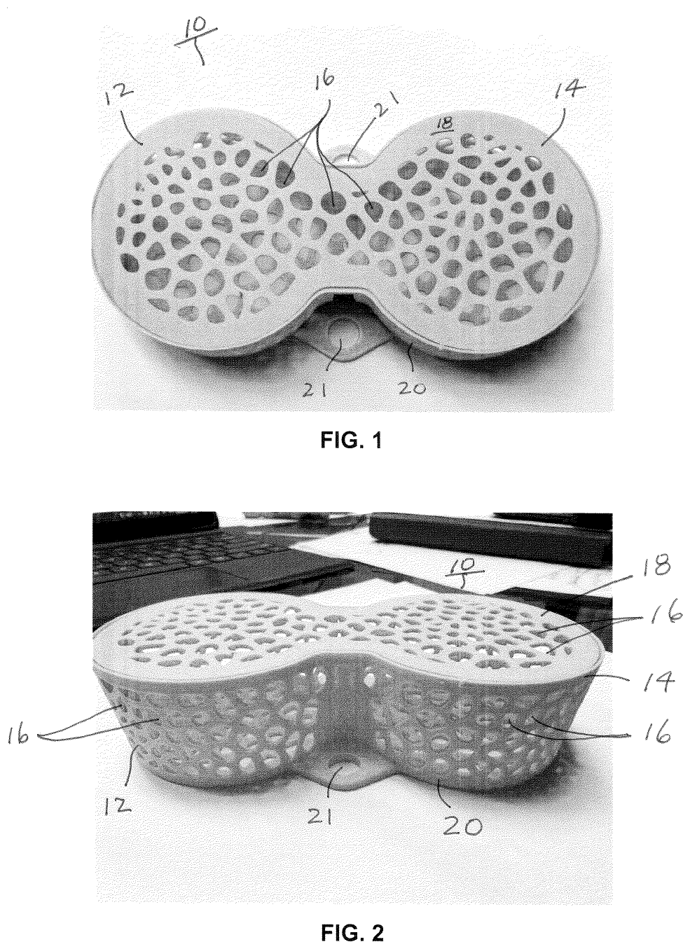

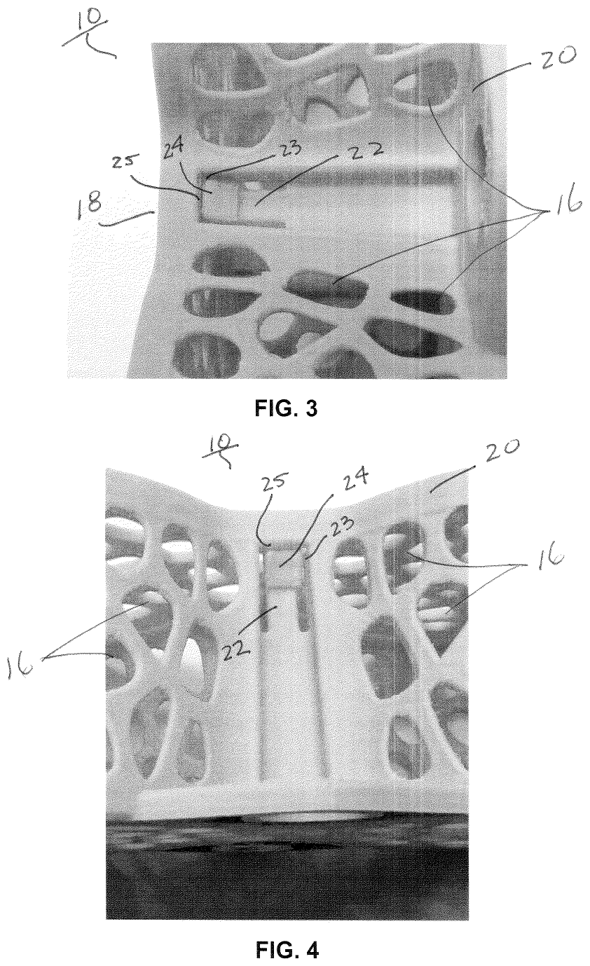

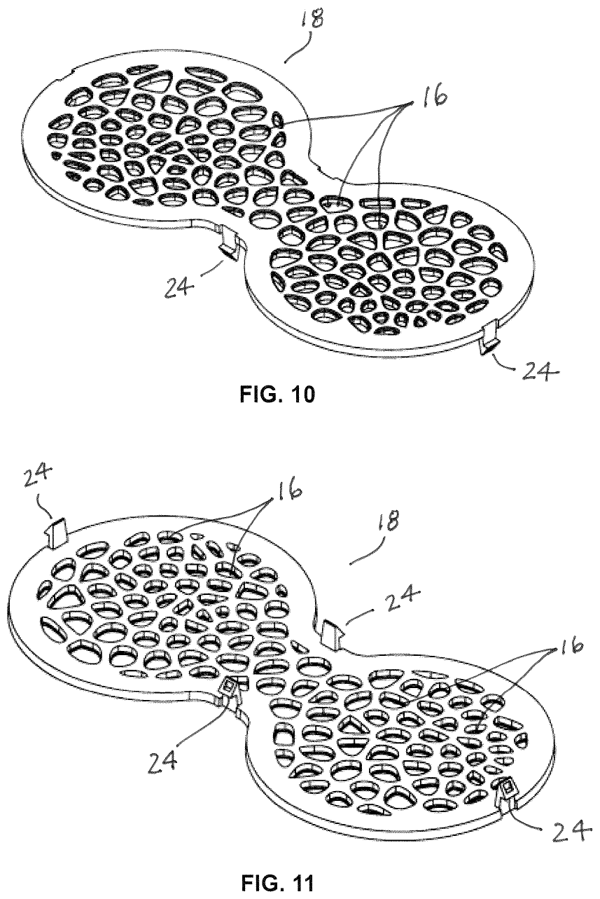

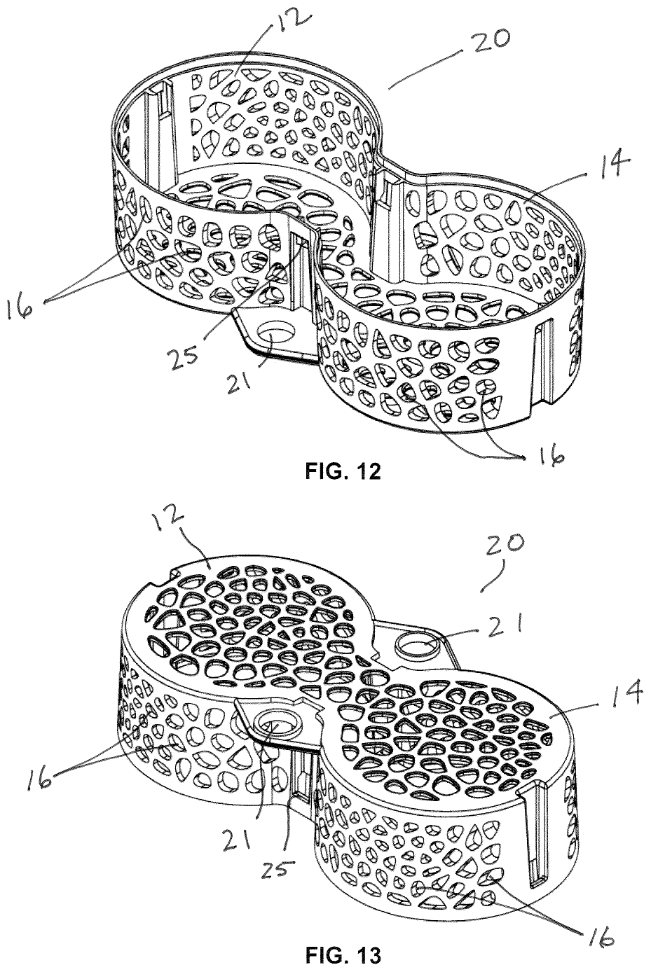

Referring to FIGS. 1 to 4, one embodiment of apparatus or enclosure 10 is shown. In some embodiments, enclosure 10 can comprise of open-top body or bottom 20 and lid 18 releasably attached thereto. Referring to FIGS. 10 and 11, illustrated are embodiments of lid 18 for use with apparatus 10. Referring to FIGS. 12 and 13, illustrated are embodiments of open-top body or bottom 20 for use with apparatus 10.

In some embodiments, enclosure 10 can comprise of one or more baskets for receiving an amount of a flocculant composition. In the illustrated embodiment, enclosure 10 comprises of two baskets: basket 12 and basket 14, each basket configured to each hold an amount of flocculant composition, which can be contained in enclosure 10 when lid 18 is placed onto and releasably attached to open-top body or bottom 20.

In some embodiments, enclosure 10 can comprise an attachment mechanism that can further comprise of catch 24 disposed on an underside of lid 18 configured to insert on top of tab 22 disposed within opening 23 of open-top body or bottom 20 wherein catch 24 can slide into contact with edge 25 to releasably attach lid 18 to open-top body or bottom 20.

In some embodiments, each of lid 18 and open-top body or bottom 20 can comprise a plurality of perforations 16 extending therethrough to allow liquids to pass through and contact flocculant compositions disposed within enclosure 10. In some embodiments, the size of perforations 16 can range from about 20% to 80% of the surface area of one or both of lid 18 and open-top body 20.

In some embodiments, perforations 16 can comprise an engineered design Voronoi pattern into the design of a plastic diffuser containing a gel flocculant (GF) clarifier for pool water treatment offers several notable benefits that enhance the efficiency and effectiveness of pool water treatment.

In some embodiments, the Voronoi pattern can create a series of interconnected, asymmetrical and irregularly shaped openings. The asymmetrical openings can allow for an uneven extrusion of GF clarifier that can create a rougher surface area (somewhat like a pebbled surface). The pebbled surface area can allow for an amplified release of the GF clarifier when inundated with turbulent flow from the circulatory pump. In some embodiments, this physical/mechanical function can be more critical as the flow values (velocity and volume) can be reduced. Pumps for pool systems can range greatly from 40 gpm to 80 gpm, typically, and even higher on large commercial systems. This range of pump volume and the resultant water velocity generated means that the GF Clarifier must be able to release in variable ranges with top efficiency. The more pebbled the surface resulting from the extrusion of GF clarifier through the Voronoi asymmetrical openings, the better the mixing and distribution of the GF clarifier evenly throughout the pool. This even distribution ensures that the GF clarifier, which can help to flocculate and remove fine particles from the water, is applied uniformly across the pool. As a result, the pool water can be treated more effectively, leading to clearer water and improved overall water quality.

In some embodiments, another significant advantage of the Voronoi pattern can be its ability to optimize water flow around the diffuser within the pool skimmer basket. By designing the diffuser with the Voronoi pattern, the water flow can be directed in a way that optimizes turbulence as well as velocity and maximizes contact time between the clarifier and the pool water. This controlled flow can help prevent areas of uneven treatment and reduces the potential for the clarifier to settle in certain regions, ensuring that the entire pool benefits from consistent and thorough treatment. This design improvement can lead to a more efficient use of the clarifier, reducing the amount required and enhancing the overall treatment process.

In some embodiments, the Voronoi design can also promote more uniform water flow through the pool filter media, reducing areas of stagnation and ensuring that the entire surface area of the pool filter is used effectively. As a result, the filter can capture a wider range of particulate matter and contaminants, improving the overall clarity and quality of the pool water.

In some embodiments, with improved efficiency in clarifier distribution and reduced operational strain, the pool's overall filtration system can operate more effectively, leading to potential energy savings and lower overall expenses for pool maintenance.

In some embodiments, enclosure 10 can comprise one or more tabs 21 for mounting enclosure as required.

In some embodiments, the composition can comprise a polymer or polymeric flocculant, which can further comprise a macromolecular organic component and have a high molecular weight. Suitable examples can include those described in U.S. Pat. Nos. 3,085,916 and 3,860,526. The proportion of the polymer in the composition can be in the range of approximately 10% to 70% by weight. The composition can further comprise any suitable soluble salt of a group IA metal or of a group IIA metal of the periodic table as well known to those skilled in the art, the proportion of which can be in the range of approximately 0.5% to 35% by weight. Examples of suitable soluble salts can include those disclosed in the above-mentioned patents. The balance of the composition can comprise water to make up the 100% weight.

In some embodiments, the soluble salt of a group IA metal or of a group IIA metal of the periodic table can be a combination of any suitable salt of a group IA metal or of a group IIA metal of the periodic table as well known to those skilled in the art, such as those metals that appear in columns IA or IIA of the chemical periodic table, as well known to those skilled in the art, with any suitable organic or mineral acid as well known to those skilled in the art. Suitable examples can include sulphuric acid, hydrochloric acid and nitric acid as mineral acids, whereas suitable organic acids can include acetic acid, boric acid, citric acid and formic acid. Other suitable mineral or organic acids can include those described in U.S. Pat. Nos. 3,085,916 and 3,860,526, the suitable selection of which can obviously be determined by those skilled in the art. The balance of the composition can comprise water to make up the 100% weight.

In some embodiments, the composition can be manufactured by first combining the polymer and the salt of a group IA metal or of a group IIA metal of the periodic table, both of which can be in solid granular or powder form, and then mixing them with the organic or mineral acid and water. In other embodiments, the salt of a group IA metal or of a group IIA metal of the periodic table can be mixed with the acid and water, and then add the polymer to the mixture.

In further embodiments, the composition can be manufactured by first combining the polymer with the soluble salt of group IA metal or of a group IIA metal of the periodic table, and then adding the balance of water. In yet further embodiments, the composition can be manufactured by first mixing the soluble salt of a group IA metal or of a group IIA metal of the periodic table with the water, and then adding the polymer.

In any of the manufacturing methods described herein, the resultant mixtures of the components of the composition can then react with each other, which can further result in the mixture setting or curing into a solid or gelatinous form. Once the components of the composition have been mixed together, there can be a working time ranging from anywhere from approximately 2 to 10 minutes to affix the shape of the composition after which the shape composition can become set or cured.

In terms of the methods of manufacture relating to whether the last component added to the mixture to form the composition is water or the polymer, it has been observed that the choice of which can result in the polymer being more soluble or less soluble. For example, if the water is the last component added to a mixture of polymer and salt of a group IA metal or of a group IIA metal of the periodic table, it is observed that the resulting composition is less soluble in terms of releasing the polymer. If the polymer is the last component added to a mixture of the soluble salt of a group IA metal or of a group IIA metal of the periodic table, it is observed that the resulting composition is more soluble in terms of releasing the polymer. The choice of manufacture can be made in respect of the application for the composition. If the composition is to be used in a closed-loop system where liquids are re-circulated through the composition, then using a composition whose polymer is less soluble may be preferable to prevent the composition being consumed or dissolved too rapidly. If the composition is to be used in an open-loop system where liquids pass through the composition once, then using a composition whose polymer is more soluble may be preferable to introduce the polymer into the liquids at a predetermined or desired rate.

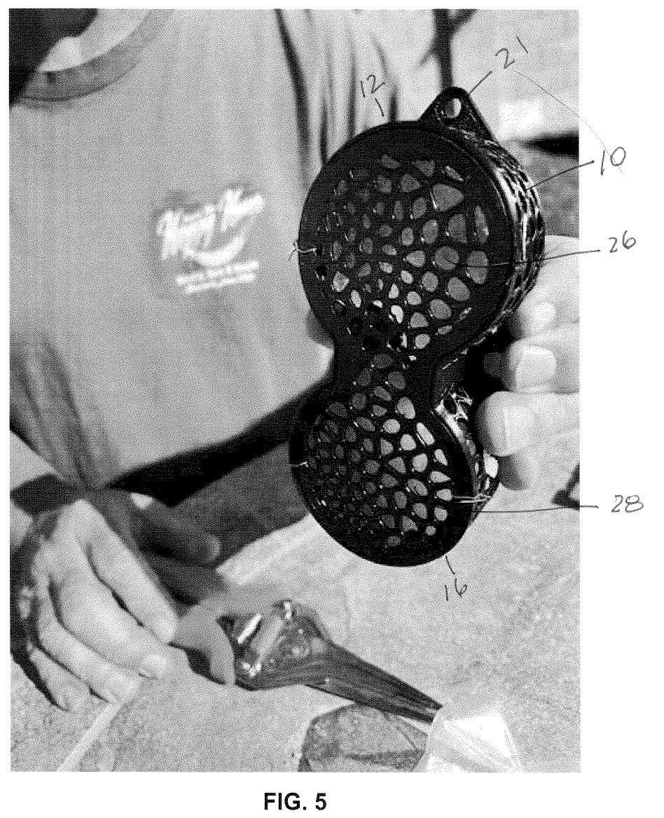

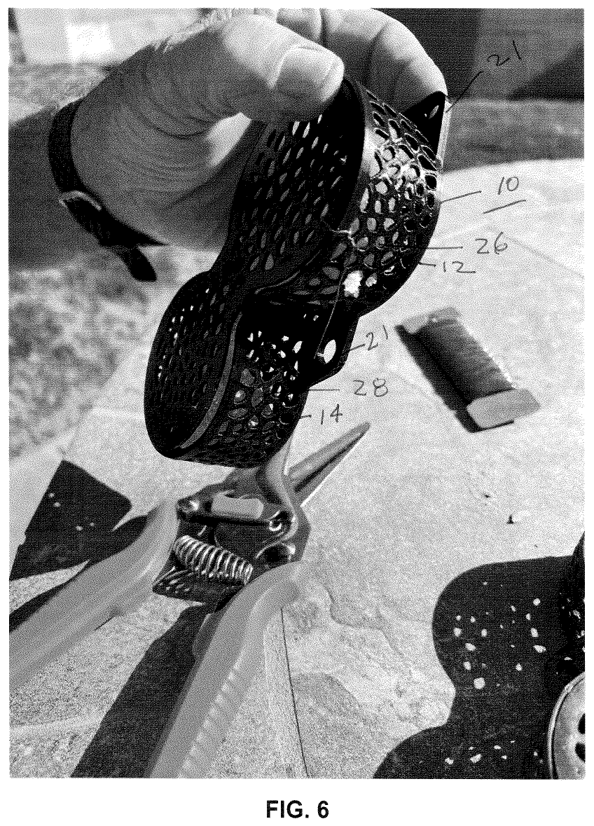

Referring to FIGS. 5 and 6, one embodiment of enclosure 10 is shown with first flocculant composition 26 disposed in basket 12, and with second flocculant composition 28 disposed in basket 14. In some embodiments, one or both of first flocculant composition 26 and second flocculant composition 28 can be comprised of a gel flocculant.

In some embodiments, a first flocculant composition 26 can be placed in one of baskets 12 or 14 wherein first flocculant composition 26 can be specifically designed or formulated to remove total suspended solids (“TSS”), which can include metals, clays, and phosphorus. In some embodiments, first flocculant composition 26 can comprise a “400 Series” gel flocculant as manufactured by Clearflow Group Inc. (“CGI”) of Sherwood Park, Alberta, Canada. In particular, first flocculant composition 26 can comprise “Gel Flocculant 494” as manufactured by CGI.

In further embodiments, a second flocculant composition can be placed in the other of baskets 12 and 14 wherein second flocculant composition 28 can be specifically designed or formulated to enhance binding of the TSS as well as the metals, clays, and phosphorus by amplifying the charge capacity of first flocculant composition 26. In some embodiments, second flocculant composition 28 can comprise a “300 Series” gel flocculant as manufactured by CGI. In particular, second flocculant composition 28 can comprise “Gel Flocculant 360” as manufactured by CGI.

In some embodiments, first flocculant composition 26 can be used to bind to TSS in the water together to precipitate or be filtered out of the water, whereas second flocculant composition 28 can enhance the tightly bound flocculated material created by first flocculant composition 26 wherein that the tightly bound flocculated material can have a sheer capacity that will not break down when pumped or piped through the pool water treatment system, which can experience high turbulence as water passes through the pool water treatment system.

As noted above, first flocculant composition 26 and second flocculant composition 28 can remove phosphorus in total and dissolved format from the water. The phosphorus is the food for the algae. Once the phosphorus is removed then the algae have no food supply and can die off. Secondarily the organic material of the algae has a charge and when one or both of first flocculant composition 26 and second flocculant composition 28 releases into the water, the ionic charges can create a binding mechanism to bind the algae with the gel flocculant. Once bound together, the agglomerated material increases in mass and size, and can precipitate out of the water. In some cases, if the specific gravity of the amassed algae is not enough to precipitate from the water, then the clumped algae can float on the surface of the water thus allowing for easy capture via filtration. The algae that have precipitated to the bottom of the pool can also easily captured via vacuum or filtration. Once removed from the water body, the continual cycle of the water in combination with the two gel flocculants through the circulatory pumps of the pool water treatment system can inhibit future growth of algae since there is no phosphorus food source for the algae.

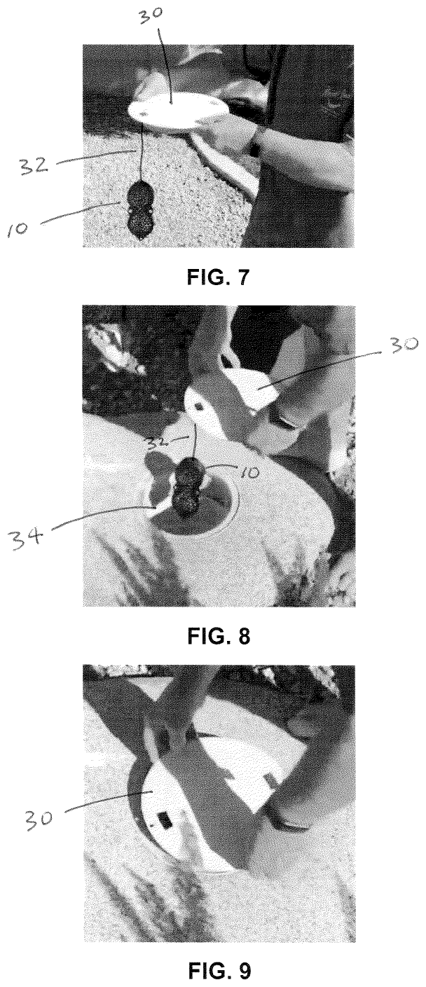

Referring to FIGS. 7 to 9, one embodiment of implementing apparatus or enclosure 10 to clarify liquid is shown. In FIG. 7, apparatus or enclosure 10 can be attached to skimmer lid 30 via line 32, which can include one or more of metal wire, polymer or plastic line (such as fishing line), and textile string.

In FIG. 8, apparatus or enclosure 10 is shown being lowered into skimmer unit 34. In FIG. 9, the installation of apparatus or enclosure 10 is being completed with the placing of skimmer lid 30 unto skimmer unit 34.

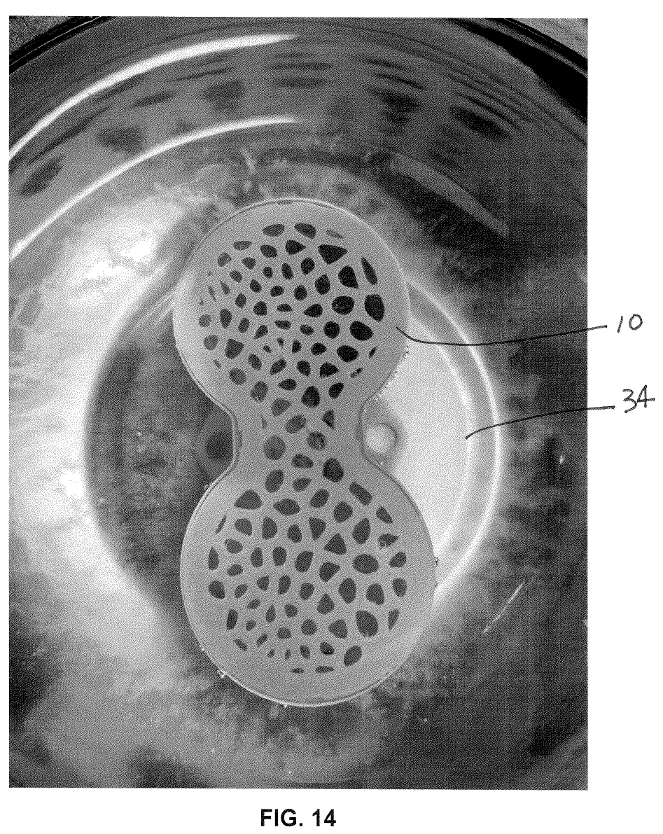

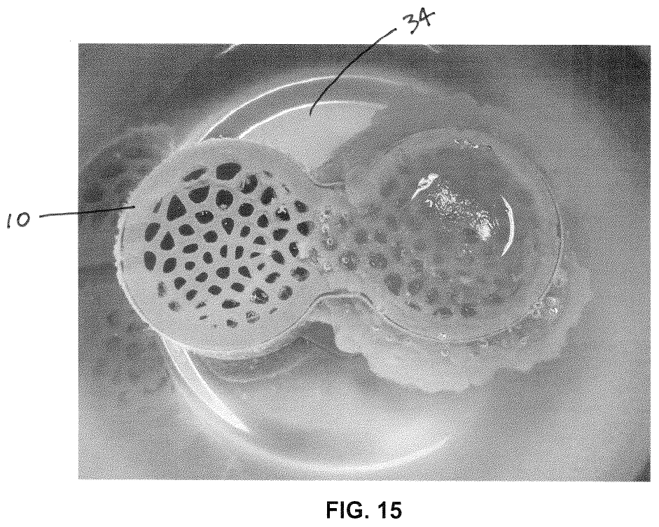

Referring to FIGS. 14 and 15, one embodiment of apparatus 10 comprising one or both of compositions 26 and 28 is shown placed in pool skimmer 34. In FIG. 15, illustrated is pool water reacting with one or both of compositions 26 and 28 disposed in apparatus 10.

In some embodiments, the apparatuses and methods described herein can eliminate or greatly reduces the need for most of the harmful chemicals required for prior art pool maintenance. In some embodiments, the maintenance of swimming pools, hot tubs, spas, and the like can be reduced to replacing apparatus 10 periodically as the gel flocculant composition material is consumed, and to maintaining the chlorine level in the water.

Thus, the benefits achieved by the apparatuses and methods described herein can include:
Elimination or reduction of harmful chemicals;
Elimination of waiting time required with prior art chemical treatments before pool can be used by humans;
Cost savings that can amount to of thousands of dollars per year;
Cleaner quality release water when the pool water is put back into the storm system when backflushing the pool water treatment system is required;
Simple one-step maintenance (just put the pack into the skimmer basket and leave it until next replacement time);
30 to 60 days between replacing gel flocculant composition, depending on the volume of water to be treated;
Less labor requirement;
In some embodiments, one gel flocculant pack can treat 15,000 gallons×4 cycles per day (60,000 gallons) for up to 60 days (depending on TSS load, flow velocity, temperature);
Will not affect pH values of the water in the swimming pool, hot tub, spa, and the like;
Full efficacy in both fresh water and salt-water ponds or pools;
Not temperature dependant as apparatuses and methods described herein can be used in temperatures ranging from freezing to boiling;
High range photosensitivity (unlike most pool chemicals which have limited capability when water is exposed to sunlight, more sunlight means more treatment and more algae);
Not combustible; and
Does not give off harmful emissions.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for clarifying a liquid, the apparatus comprising:
a) a perforated enclosure; and
b) at least one first flocculant composition disposed in the perforated enclosure.

2. The apparatus as set forth in claim 1, wherein the at least one first flocculant composition comprises:
a) a polymer flocculant comprising a high molecular weight, in a proportion of approximately 10% to 70% by weight;
b) a soluble salt of a group IA metal or a soluble salt of a group IIA metal, in a proportion of approximately 0.5% to 35% by weight; and
c) water, in a proportion to make up a balance of 100% weight.

3. The apparatus as set forth in claim 1, further comprising at least one second flocculant composition disposed in the perforated enclosure.

4. The apparatus as set forth in claim 3, wherein the at least one second flocculant composition comprises:
a) a polymer flocculant comprising a high molecular weight, in a proportion of approximately 10% to 70% by weight;
b) a soluble salt of a group IA metal or a soluble salt of a group IIA metal, in a proportion of approximately 0.5% to 35% by weight; and
c) water, in a proportion to make up a balance of 100% weight.

5. The apparatus as set forth in claim 3, wherein the at least one second flocculant composition comprises a different composition than that of the at least one first flocculant composition.

6. The apparatus as set forth in claim 1, wherein the enclosure comprises an open-top body and a lid configured to releasably attach to the open-top body.

7. The apparatus as set forth in claim 6, further comprising a catch mechanism for releasably attaching the lid to the open-top body.

8. The apparatus as set forth in claim 2, wherein the at least one first flocculant composition comprises a gel flocculant.

9. The apparatus as set forth in claim 4, wherein the at least one second flocculant composition comprises a gel flocculant.

10. The apparatus as set forth in claim 1, wherein the liquid comprises water from one or more of a swimming pool, a hot tub, and a spa.

11. A method for clarifying liquids, the method comprising placing an apparatus into a liquid treatment system, the apparatus comprising:
a) a perforated enclosure; and
b) at least one first flocculant composition disposed in the perforated enclosure.

12. The method as set forth in claim 11, wherein the at least one first flocculant composition comprises:
a) a polymer flocculant comprising a high molecular weight, in a proportion of approximately 10% to 70% by weight;
b) a soluble salt of a group IA metal or a soluble salt of a group IIA metal, in a proportion of approximately 0.5% to 35% by weight; and
c) water, in a proportion to make up a balance of 100% weight.

13. The method as set forth in claim 11, wherein the apparatus further comprises at least one second flocculant composition disposed in the perforated enclosure.

14. The method as set forth in claim 13, wherein the at least one second flocculant composition comprises:
a) a polymer flocculant comprising a high molecular weight, in a proportion of approximately 10% to 70% by weight;
b) a soluble salt of a group IA metal or a soluble salt of a group IIA metal, in a proportion of approximately 0.5% to 35% by weight; and
c) water, in a proportion to make up a balance of 100% weight.

15. The method as set forth in claim 13, wherein the at least one second flocculant composition comprises a different composition than that of the at least one first flocculant composition.

16. The method as set forth in claim 11, wherein the enclosure comprises an open-top body and a lid configured to releasably attach to the open-top body.

17. The method as set forth in claim 16, further comprising a catch mechanism for releasably attaching the lid to the open-top body.

18. The method as set forth in claim 12, wherein the at least one first flocculant composition comprises a gel flocculant.

19. The method as set forth in claim 14, wherein the at least one second flocculant composition comprises a gel flocculant.

20. The method as set forth in claim 11, further comprising placing the apparatus into a skimmer unit of a water treatment system for one or more of a swimming pool, a hot tub, and a spa.
